(19) United States
(12) Patent Application Publication
(10) Pub. No.: US 2026/0357890 A1
(43) Pub. Date: Nov. 12, 2026

(54) GEAR SHIFT CONTROL METHOD, AND VEHICLE AND STORAGE MEDIUM

(71) Applicant: CHONGQING CHANGAN AUTOMOBILE CO., LTD., Chongqing (CN)

(72) Inventor: Junming LAN, Chongqing (CN)

(73) Assignee: CHONGQING CHANGAN AUTOMOBILE CO., LTD., Chongqing (CN)

(21) Appl. No.: 19/710,705

(22) Filed: Jun. 17, 2026

Related U.S. Application Data
(63) Continuation of application No. PCT/CN2024/143467, filed on Dec. 27, 2024.

(30) Foreign Application Priority Data
Jan. 2, 2024 (CN) 202410012854.5

(51) Int. Cl. F16H 61/02; F16H 59/44; F16H 59/54; F16H 61/12

(52) U.S. Cl. CPC F16H 61/0213; F16H 59/44; F16H 59/54; F16H 61/12; F16H 2061/1208

(57) ABSTRACT

The present disclosure relates to a gear shift control method, a vehicle, and a non-transitory computer-readable storage medium. The gear shift control method is applied to a gear shift control system, and includes: obtaining voltage information of gear shift control hardware in a target vehicle; determining target I/O information based on the voltage information; determining an atomic service output gear based on the target I/O information; determining a target gear based on vehicle state information of the target vehicle and the atomic service output gear; and controlling a gear of the target vehicle based on the target gear.

### CROSS-REFERENCE TO RELATED APPLICATIONS

The present disclosure is a continuation-application of International (PCT) Patent Application No. PCT/CN2024/143467 filed on Dec. 27, 2024, which claims priority of Chinese Patent Application No. 202410012854.5, filed on Jan. 2, 2024 in the China National Intellectual Property Administration, the contents of which are hereby incorporated by reference.

### TECHNICAL FIELD

The present disclosure relates to the field of vehicle control technologies, and in particular, to a gear shift control method, a vehicle, and a non-transitory computer-readable storage medium.

### BACKGROUND

Service Oriented Architecture (SOA) is a software architecture design concept. A core idea of the SOA is to encapsulate an underlying function of each controller in a form of a service. Each service is an independent and executable software component assigned with a specific IP address and standardized interface for easy calling at any time. Finally, a complex intelligent function can be achieved through flexible combination of these underlying functions.

Automobiles are gradually developed from a distributed architecture to a centralized architecture. It is obvious in the waste of a hardware resource and a capability caused by a distributed electronic and electrical architecture. Different suppliers are responsible for the development of different Electronic Control Units (ECUs). Dozens of ECUs in an entire vehicle are respectively responsible for implementing specific software and hardware functions, and then interact with another through hardware or network signals. Due to various factors such as a research and development cycle, a project resource, technological development, a supplier capability, and vehicle manufacturer capabilities, the evolution from distributed electronic and electrical architecture to the centralized electronic and electrical architecture is an inevitable trend. With the development of chip technology, a powerful chip forms the underlying hardware foundation for implementing SOA.

With the continuous development of automobile manufacturing technology, a requirement of a user for a vehicle is also increasing. However, in an architecture of traditional gear shift control, hardware and software is highly coupled, resulting in an increase in software versions, a large amount of code workload, and a low degree of software phantomization.

### SUMMARY

In a first aspect, the present disclosure provides a gear shift control method, the gear shift control method is applied to the gear shift control system. The gear shift control method includes:
obtaining voltage information of gear shift control hardware in a target vehicle;
determining target I/O information based on the voltage information;
determining an atomic service output gear based on the target I/O information;
determining a target gear based on vehicle state information of the target vehicle and the atomic service output gear; and
controlling a gear of the target vehicle based on the target gear.

In a second aspect, the present disclosure also provides a vehicle, including a processor and a memory. The memory is configured to store a control program, and in a case where the control program is executed by the processor, the processor is caused to perform:
obtaining voltage information of gear shift control hardware in a target vehicle;
determining target I/O information based on the voltage information;
determining an atomic service output gear based on the target I/O information;
determining a target gear based on vehicle state information of the target vehicle and the atomic service output gear; and
controlling a gear of the target vehicle based on the target gear.

In a third aspect, the present disclosure also provides a non-transitory computer-readable storage medium. The non-transitory computer-readable storage medium is configured to store one or at least one program, in a case where the one or at least one program is executed by one or at least one processor, the one or at least one processor is caused to perform:
obtaining voltage information of gear shift control hardware in a target vehicle;
determining target I/O information based on the voltage information;
determining an atomic service output gear based on the target I/O information;
determining a target gear based on vehicle state information of the target vehicle and the atomic service output gear; and
controlling a gear of the target vehicle based on the target gear.

### BRIEF DESCRIPTION OF THE DRAWINGS

FIG. 1 shows a schematic view of a gear shift control system provided by some embodiments of the present disclosure;

FIG. 2 shows a flowchart of a gear shift control method provided by some embodiments of the present disclosure;

FIG. 3 shows a structural schematic view of a vehicle provided by some embodiments of the present disclosure.

In the drawings, reference numerals are used as follows: 10, I/O hardware abstraction layer; 20, atomic service layer; 30, enhance service layer; 40, gear application layer; 50, gear shift control hardware layer; 100, vehicle; 101, processor; 102, memory; 1021, operating system; 1022, application program; 103, user interface; 104, network interface; 105, bus system.

### DETAILED DESCRIPTION OF THE PREFERRED EMBODIMENTS

Implementation of the present disclosure will be described below with reference to the accompanying drawings and preferred embodiments. Those skilled in the art may readily appreciate other advantages and effects of the present disclosure from the disclosure set forth in the disclosure. The present disclosure may also be implemented or applied in other various specific implementations. Various modifications and changes may be made to the details of the present disclosure based on different perspectives and applications without departing from the spirit of the present disclosure. It should be understood that the preferred embodiments are only illustrating the present disclosure and are not intended to limit the protection scope thereof.

It should be noted that the drawings provided by the following embodiments only illustrate the basic concept of the present disclosure in a schematic manner. Therefore, the drawings only show components relevant to the present disclosure, rather than being drawn according to the actual number, shape, and size of components in actual implementation. The form, quantity, and proportion of each component in actual implementation may be adjusted arbitrarily, and the layout form of the components may also be more complex.

In some embodiments, the present disclosure provides a gear shift control method, applied to the gear shift control system. The gear shift control method includes: obtaining voltage information of gear shift control hardware in a target vehicle; determining target I/O information based on the voltage information; determining an atomic service output gear based on the target I/O information; determining a target gear based on vehicle state information of the target vehicle and the atomic service output gear; and controlling a gear of the target vehicle based on the target gear.

In an embodiment, the obtaining voltage information of gear shift control hardware in a target vehicle may include: obtaining first voltage information corresponding to a parking gear in the gear shift control hardware; and determining the first voltage information as information corresponding to the parking gear in the target I/O information.

In an embodiment, the obtaining voltage information of gear shift control hardware in a target vehicle may include: obtaining second voltage information corresponding to a non-parking gear in the gear shift control hardware; abstracting the second voltage information into digital quantity information; and determining the digital quantity information as information corresponding to the non-parking gear in the target I/O information.

In an embodiment, the determining a target gear based on vehicle state information of the target vehicle and the atomic service output gear may include: determining a fault state of the gear shift control hardware based on the target I/O information; in a case where the gear shift control hardware is fault-free, transmitting a gear corresponding to the target I/O information in gear configuration information as the atomic service output gear; wherein the gear configuration information includes at least one correspondence relationship between I/O information and the gear.

In an embodiment, the vehicle state information includes a brake pedal state, a drivable mode state, an electronic parking brake system state, and a vehicle driving speed, and the determining a target gear based on vehicle state information of the target vehicle and the atomic service output gear may include: determining a driver gear demand based on the brake pedal state, a drivable mode state, an electronic parking brake system state, a vehicle driving speed, and the atomic service output gear; and performing gear arbitration to determine the target gear based on an internal gear demand of a power system, an intelligent driving gear demand, and the driver gear demand.

In an embodiment, a priority of the intelligent driving gear demand is higher than a priority of the internal gear demand of the power system, and the priority of the internal gear demand of the power system is higher than a priority of the driver gear demand.

In an embodiment, the vehicle state information includes a column shifter lever state, a power gear, and a set vehicle mode; and the determining a target gear based on vehicle state information of the target vehicle and the atomic service output gear may include: determining the internal gear demand of the power system based on the column shifter lever state, the power gear, and the set vehicle mode.

In an embodiment, the vehicle state information includes an intelligent driving gear request state, the drivable mode state, and the vehicle driving speed; and the determining a target gear based on vehicle state information of the target vehicle and the atomic service output gear may include: determining the intelligent driving gear demand based on the intelligent driving gear request state, the drivable mode state, and the vehicle driving speed.

In an embodiment, the controlling a gear of the target vehicle based on the target gear may include: obtaining an EPB state, the vehicle speed, torque information, and a power gear; and controlling the gear of the target vehicle based on the EPB state, the vehicle speed, the torque information, the power gear, and the target gear.

In some embodiments, the present disclosure provides a vehicle, including a processor and a memory. The memory is configured to store a control program, in a case where the control program is executed by the processor, the processor is caused to perform: obtaining voltage information of gear shift control hardware in a target vehicle; determining target I/O information based on the voltage information; determining an atomic service output gear based on the target I/O information; determining a target gear based on vehicle state information of the target vehicle and the atomic service output gear; and controlling a gear of the target vehicle based on the target gear.

In an embodiment, in a case where the control program is executed by the processor, the processor is caused to perform: obtaining first voltage information corresponding to a parking gear in the gear shift control hardware; and determining the first voltage information as information corresponding to the parking gear in the target I/O information.

In an embodiment, in a case where the control program is executed by the processor, the processor is caused to perform: obtaining second voltage information corresponding to a non-parking gear in the gear shift control hardware; abstracting the second voltage information into digital quantity information; and determining the digital quantity information as information corresponding to the non-parking gear in the target I/O information.

In an embodiment, in a case where the control program is executed by the processor, the processor is caused to perform: determining a fault state of the gear shift control hardware based on the target I/O information; in a case where the gear shift control hardware is fault-free, transmitting a gear corresponding to the target I/O information in gear configuration information as the atomic service output gear; wherein the gear configuration information includes at least one correspondence relationship between I/O information and the gear.

In an embodiment, the vehicle state information includes a brake pedal state, a drivable mode state, an electronic parking brake system state, and a vehicle driving speed, and, in a case where the control program is executed by the processor, the processor is caused to perform: determining a driver gear demand based on the brake pedal state, a drivable mode state, an electronic parking brake system state, a vehicle driving speed, and the atomic service output gear; and performing gear arbitration to determine the target gear based on an internal gear demand of a power system, an intelligent driving gear demand, and the driver gear demand.

In an embodiment, a priority of the intelligent driving gear demand is higher than a priority of the internal gear demand of the power system, and the priority of the internal gear demand of the power system is higher than a priority of the driver gear demand.

In an embodiment, the vehicle state information includes a column shifter lever state, a power gear, and a set vehicle mode; and, in a case where the control program is executed by the processor, the processor is caused to perform: determining the internal gear demand of the power system based on the column shifter lever state, the power gear, and the set vehicle mode.

In an embodiment, the vehicle state information includes an intelligent driving gear request state, the drivable mode state, and the vehicle driving speed; and in a case where the control program is executed by the processor, the processor is caused to perform: determining the intelligent driving gear demand based on the intelligent driving gear request state, the drivable mode state, and the vehicle driving speed.

In an embodiment, in a case where the control program is executed by the processor, the processor is caused to perform: obtaining an EPB state, the vehicle speed, torque information, and a power gear; and controlling the gear of the target vehicle based on the EPB state, the vehicle speed, the torque information, the power gear, and the target gear.

In some embodiments, the present disclosure provides a non-transitory computer-readable storage medium. The non-transitory computer-readable storage medium stores one or at least one program, in a case where the one or at least one program is executed by one or at least one processor, the one or at least one processor is caused to perform: obtaining voltage information of gear shift control hardware in a target vehicle; determining target I/O information based on the voltage information; determining an atomic service output gear based on the target I/O information; determining a target gear based on vehicle state information of the target vehicle and the atomic service output gear; and controlling a gear of the target vehicle based on the target gear.

In an embodiment, in a case where the one or at least one program is executed by one or at least one processor, the one or at least one processor is caused to perform: obtaining first voltage information corresponding to a parking gear in the gear shift control hardware; and determining the first voltage information as information corresponding to the parking gear in the target I/O information.

In some embodiments, the present disclosure provides a gear shift control system, including: an I/O hardware abstraction layer, configured to obtain voltage information of gear shift control hardware in a target vehicle, and determine target I/O information based on the voltage information; an atomic service layer, configured to determine an atomic service output gear based on the target I/O information output by the I/O hardware abstraction layer, and transmit the atomic service output gear to an enhanced service layer; the enhanced service layer, configured to determine a target gear based on vehicle state information of the target vehicle and the atomic service output gear; and a gear application layer, configured to control a gear of the target vehicle based on the target gear obtained from the enhanced service layer.

In an embodiment, the I/O hardware abstraction layer is configured to: obtain first voltage information corresponding to a parking gear in the gear shift control hardware; and determine the first voltage information as information corresponding to the parking gear in the target I/O information.

In an embodiment, the I/O hardware abstraction layer is configured to: obtain second voltage information corresponding to a non-parking gear in the gear shift control hardware; abstract the second voltage information into digital quantity information; and determine the digital quantity information as information corresponding to the non-parking gear in the target I/O information.

In an embodiment, the atomic service layer is configured to: determine a fault state of the gear shift control hardware based on the target I/O information; in a case where the gear shift control hardware is fault-free, transmit a gear corresponding to the target I/O information in gear configuration information as the atomic service output gear to the enhanced service layer; wherein the gear configuration information includes at least one correspondence relationship between I/O information and the gear.

In an embodiment, the vehicle state information includes a brake pedal state, a drivable mode state, an electronic parking brake system state, and a vehicle driving speed, and the enhanced service layer is configured to:
determine a driver gear demand based on the brake pedal state, a drivable mode state, an electronic parking brake system state, a vehicle driving speed, and the atomic service output gear; and
perform gear arbitration to determine the target gear based on an internal gear demand of a power system, an intelligent driving gear demand, and the driver gear demand.

In an embodiment, a priority of the intelligent driving gear demand is higher than a priority of the internal gear demand of the power system, and the priority of the internal gear demand of the power system is higher than a priority of the driver gear demand.

In an embodiment, the vehicle state information includes a column shifter lever state, a power gear, and a set vehicle mode; and the enhanced service layer is configured to: determine the internal gear demand of the power system based on the column shifter lever state, the power gear, and the set vehicle mode.

In an embodiment, the vehicle state information includes an intelligent driving gear request state, the drivable mode state, and the vehicle driving speed; and the enhanced service layer is configured to:
determine the intelligent driving gear demand based on the intelligent driving gear request state, the drivable mode state, and the vehicle driving speed.

In an embodiment, the gear application layer is configured to: obtain an EPB state, the vehicle speed, torque information, and a power gear; and control the gear of the target vehicle based on the EPB state, the vehicle speed, the torque information, the power gear, and the target gear.

In the present disclosure, the gear shift control system of the SOA architecture may modularize and standardize originally dispersed electronic control units (ECUs) and basic software functions thereof in gear shift control, decouple various application domains from one another, and redeploy the various application domains into a layered software architecture. The vehicle can provide different gear shift control services through different software configurations without adding or replacing the hardware. The present disclosure may reduce coupling degree between the hardware and the software related to gear shift control, even decouple the corresponding software and the hardware, reduce the software versions and the code volume, improve the degree of software platformization, provide a personalized gear shift control service, and facilitate subsequent maintenance and upgrade of the gear shift control, thereby enhancing the gear shift control experience.

In order to facilitate the understanding of the embodiments of the present disclosure, further explanation will be provided below with specific embodiments with reference to the accompanying drawings. The embodiments do not constitute limitations on the embodiments of the present disclosure.

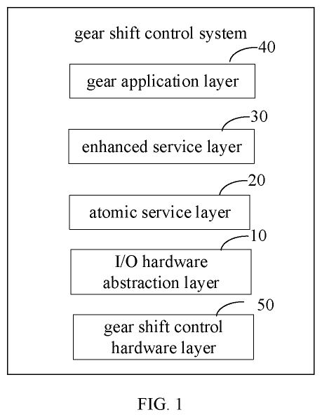

The embodiments provide a gear shift control system, and the gear shift control system may be applied to a vehicle. Referring to FIG. 1, the system can be an SOA architecture system, including an I/O hardware abstraction layer 10, an atomic service layer 20, an enhanced service layer 30, and a gear application layer 40. The system defines a service name, a calling method, a data type, and the like for each service layer. Based on the function of an I/O port, it is determined whether a service adopts a writing mode (Set, RR) or a notification mode (Notify), and the data type is a parameter name specific to the I/O port, such as a fault state of a PIN, a collected signal value, a drive command, and so on.

The I/O hardware abstraction layer 10 may be bound to relevant hardware (referred to as gear shift control hardware) in the gear shift control hardware layer 50 of the gear shift control system to obtain physical state information of the gear shift control hardware in a target vehicle. The physical state information may include voltage information.

The I/O hardware abstraction layer 10 may determine target I/O information based on the voltage information. The target I/O information may be used by the atomic service layer 20. That is, the I/O hardware abstraction layer 10 may be configured to characterize the obtained voltage information of the gear shift control hardware to obtain the target I/O information for the atomic service layer 20 to call.

The gear of the target vehicle can be divided into a parking gear (i.e. P gear) and a non-parking gear. The non-parking gear may include a reverse gear (i.e. R gear), a neutral gear (i.e. N gear), and a forward gear (i.e. D gear).

For the parking gear, the I/O hardware abstraction layer 10 may be configured to obtain voltage information corresponding to the parking gear in the gear shift control hardware (referred to as first voltage information), and may be configured to determine the first voltage information as information corresponding to the parking gear in the target I/O information. The parking gear may adopt separate two hard wires to input to the I/O hardware abstraction layer 10.

For the non-parking gear, the I/O hardware abstraction layer 10 may be configured to obtain voltage information corresponding to the non-parking gear in gear shift control hardware (referred to as second voltage information), and may be configured to abstract the second voltage information into digital quantity information. In the digital quantity information, “0” represents a low level and “1” represents a high level.

The atomic service layer 20 may be configured to monitor representation information of hardware state changes (i.e. the target I/O information) sent by the I/O hardware abstraction layer 10, and may be configured to transmit a corresponding functional meaning interface to other modules after signal processing and filtering. That is, the atomic service layer 20 in the gear shift control system may be configured to determine an atomic service output gear based on the target I/O information output by the I/O hardware abstraction layer 10, and may be configured to transmit the atomic service output gear to the enhanced service layer 30.

It should be noted that before outputting the atomic service output gear to the enhanced service layer 30, the atomic service layer 20 may be configured to first determine a fault state of the gear shift control hardware based on the target I/O information obtained from the I/O hardware abstraction layer 10. In a case where the gear shift control hardware is fault-free, a gear corresponding to the target I/O information in gear configuration information may be transmitted to the enhanced service layer 30 as the atomic service output gear. The gear configuration information includes at least one correspondence relationship between I/O information and the gear.

In some embodiments, the gear configuration information may be stored in a form of a gear configuration table.

Gear configuration table

| | I/O information | | | | | |
|---|---|---|---|---|---|---|
| | first | second | third | fourth | fifth | sixth |
| gear | Hall | Hall | Hall | Hall | Hall | Hall |
| R gear | 0 | 0 | 0 | 1 | 1 | 0 |
| N gear upper half | 0 | 0 | 0 | 0 | 1 | 1 |
| travel | | | | | | |
| N gear | 0 | 0 | 1 | 0 | 0 | 1 |
| N gear lower half | 0 | 1 | 1 | 0 | 0 | 0 |
| travel | | | | | | |
| D gear | 1 | 1 | 0 | 0 | 0 | 0 |

The second voltage information may include voltage information detected by six Hall sensors, and the I/O hardware abstraction layer 10 may be configured to obtain digital quantity information based on the second voltage information. The digital quantity information may include six values. Each value may be either “0” or “1”. The “0” indicates that the voltage information detected by the Hall sensor corresponding to the value is at a low level, and “1” indicates that the voltage information detected by the Hall sensor corresponding to the value is at a high level. It should be noted that the six Hall sensors may be respectively referred to as the first Hall, the second Hall, the third Hall, the fourth Hall, the fifth Hall, and the sixth Hall.

In the embodiments, according to the gear configuration table, in a case where the values corresponding to the first Hall, the second Hall, the third Hall, the fourth Hall, the fifth Hall, and the sixth Hall are determined to be 0, 0, 0, 1, 1, and 0 in sequence, the atomic service output gear may be determined as the R gear.

It should be noted that in addition to determining the atomic service output gear by the above method, determination may also be implemented by other methods, which is not limited herein.

The enhanced service layer 30 may be configured to determine a target gear based on vehicle state information of the target vehicle and the atomic service output gear. That is, the enhanced service layer 30 may be configured to monitor a state of an atomic service related to the gear hardware and other atomic services of the vehicle, and may be configured to arbitrate and control monitored information for the gear shift control function of the gear application layer 40 to call.

It should be noted that the vehicle state information may include a brake pedal state, a drivable mode state, an electronic parking brake system state, and a vehicle driving speed and the like, and may also be set to include other information according to the actual situation, and it is not limited herein.

The gear application layer 40 may be configured to control the gear of the target vehicle based on the target gear obtained from the enhanced service layer 30, thereby achieving gear shift control of the target vehicle.

In a case where the gear application layer 40 controls the gear of the target vehicle, the gear application layer 40 may be configured to first obtain an EPB state, the vehicle speed, torque information, and a power gear. The gear application layer 40 may also configured to obtain other information of the target vehicle according to actual need, and it is not limited herein. The above information is used to determine a specific parameter adjustment required for the target vehicle to adjust to the target gear, that is, the above information is used to determine a specific gear adjustment plan.

The gear application layer 40 may be configured to control the gear of the target vehicle based on the EPB state, the vehicle speed, the torque information, the power gear, and the target gear transmitted by the enhanced service layer 30, after obtaining the EPB state, the vehicle speed, the torque information, the power gear, and so on mentioned above.

A gear shift control application module of the gear application layer 40 is configured to call the enhanced service corresponding to the enhanced service layer 30 to complete the gear shift control of the entire vehicle. For example, the driving control is performed based on a gear output by the enhanced service, including forward, reverse, and parking, and the like. A high-voltage power-on function is performed based on the gear output by the enhanced service, and the high-voltage power-on is only permitted in the P gear or the N gear. A central control screen is configured to call an actual gear enhancement service for gear display and other purposes, which is not limited herein.

Through the SOA architecture, including the gear shift control hardware layer 50, the I/O hardware abstraction layer 10, the atomic service layer 20, the enhanced service layer 30, and the gear application layer 40, the gear shift control system may modularize and standardize originally dispersed electronic control units (ECUs) and basic software functions thereof in gear shift control, decouple various application domains from one another, and redeploy the various application domains into a layered software architecture. The vehicle can provide different gear shift control services through different software configurations without adding or replacing the hardware. The present disclosure may reduce coupling degree between the hardware and the software related to gear shift control, even decouple the corresponding software and the hardware, reduce the software versions and the code volume, improve the degree of software platformization, provide a personalized gear shift control service, and facilitate subsequent maintenance and upgrade of the gear shift control, thereby enhancing the gear shift control experience.

Some embodiments of the present disclosure provide a gear shift control system applied to a vehicle. Referring to FIG. 1, in the system, the vehicle state information may include a brake pedal state, a drivable mode state, an electronic parking brake system state, and a vehicle driving speed and the like.

The enhanced service layer 30 may be configured to the enhanced service layer is configured to determine a driver gear demand based on the brake pedal state, a drivable mode state, an electronic parking brake (EPB) system state, a vehicle driving speed, and the atomic service output gear; and then perform gear arbitration to determine the target gear based on an internal gear demand of a power system, an intelligent driving gear demand, and the driver gear demand.

During the gear arbitration, the target gear may be selected based on priorities of the intelligent driving gear demand, the internal gear demand of the power system, and the driver gear demand. In some embodiments, a priority of the intelligent driving gear demand is higher than a priority of the internal gear demand of the power system, and the priority of the internal gear demand of the power system is higher than a priority of the driver gear demand. It should be noted that the priorities of the above three gear demands can also be set to other situations according to the actual situation, it is not limited herein.

The driver gear demand mainly comes from a state of a shift lever, that is, gear output by a shift atomic service (i.e. the atomic service output gear, such as P gear, R gear, N gear, or D gear), and it is necessary to determine the brake pedal state, the drivable mode state, whether the EPB is released, and the vehicle driving speed, and so on. For example, in a case where the D gear is shifted to the P gear, the driver needs to press a brake pedal, the vehicle speed is less than 3 km/h, and the atomic service output gear is in the P gear. It may be determined that the driver demand gear is the P gear only in a case where the above conditions are satisfied, and subsequent logic is allowed to perform.

The internal gear demand of a power system refers to a request for the entire vehicle to shift gears. For example, in a case where an automatic vehicle wash mode is detected to be activated, the vehicle is currently in an ON gear (in response to the key being turned to this position, an entire vehicle circuit is connected, and the system will make a necessary preparation and self-check work for starting an engine. In a case where the vehicle is driving normally, the key will remain in this position. In a case where the key is in an ON state during normal driving, all circuits in the vehicle are in a working state), under these circumstances, the gear needs to be set to the N gear.

The intelligent driving gear demand refers to the response to the intelligent driving gear demand (such as the P gear, the R gear, the D gear, or the like) in a case where the vehicle is in a drivable mode, the intelligent driving function is activated, and there is a gear request from the intelligent driving.

In addition, the internal gear demand of the power system and the intelligent driving gear demand may also be determined by the enhanced service layer 30.

In some embodiments, the vehicle state information may include a column shifter lever state, a power gear, and a set vehicle mode. The set vehicle mode may include an automatic vehicle wash mode, a bench mode, a trailer mode, and so on, and it is not limited herein. In the embodiments, the enhanced service layer 30 is configured to determine the internal gear demand of the power system based on the column shifter lever state, the power gear, and the set vehicle mode.

In some embodiments, the vehicle state information may include an intelligent driving gear request state, the drivable mode state, and the vehicle driving speed. In the embodiments, the enhanced service layer 30 is configured to determine the intelligent driving gear demand based on the intelligent driving gear request state, the drivable mode state, and the vehicle driving speed.

It should be noted that, in addition to determining the internal gear demand and intelligent driving gear demand of the power system through the above method, other methods can also be used to determine the internal gear demand and intelligent driving gear demand of the power system, and it is not limited herein.

In the gear shift control system, the enhanced service layer 30 comprehensively judges the state of the entire vehicle, receives feedback from various atomic services, arbitrates the gear of the vehicle, and determines the target gear. The target gear may be determined to complete the actual gear shifting based on atomic services such as the brake pedal atomic service, the drivable mode atomic service, the EPB state atomic service, the vehicle speed atomic service, and an ADAS gear atomic service, so as to improve the reliability of the entire gear shift control and enhance the driving experience.

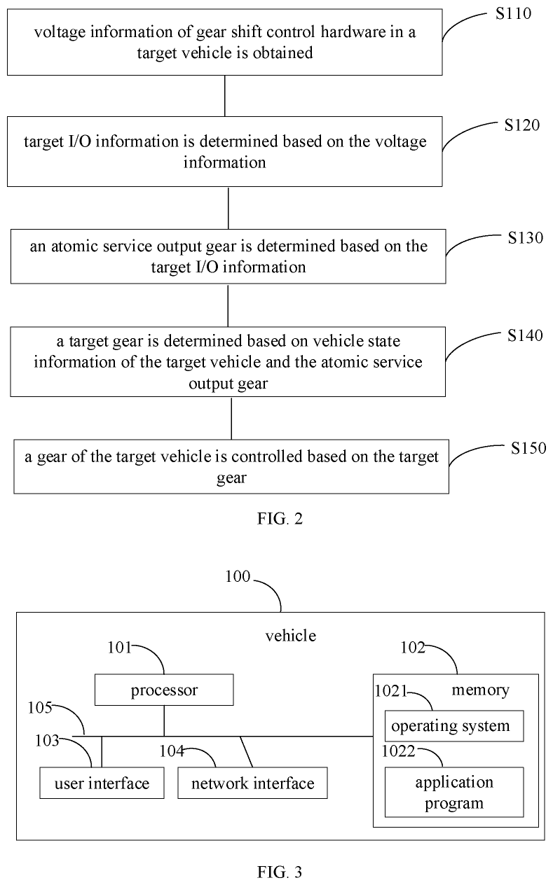

Some embodiments of the present disclosure provide a gear shift control method applied to the gear shift control system described above. Referring to FIG. 1 and FIG. 2, the method may include operations at the following blocks.

At block S110, voltage information of gear shift control hardware in a target vehicle is obtained.

At block S120, target I/O information is determined based on the voltage information.

At block S130, an atomic service output gear is determined based on the target I/O information.

At block S140, a target gear is determined based on vehicle state information of the target vehicle and the atomic service output gear.

At block S150, a gear of the target vehicle is controlled based on the target gear.

In the operations at block S110, the I/O hardware abstraction layer 10 in the gear shift control system may be bound to relevant hardware (referred to as gear shift control hardware) in the gear shift control hardware layer 50 of the gear shift control system to obtain physical state information of the gear shift control hardware in a target vehicle. The physical state information may include voltage information.

In the operations at block S120, the I/O hardware abstraction layer 10 may determine target I/O information based on the voltage information. The target I/O information may be used by the atomic service layer 20. That is, the I/O hardware abstraction layer 10 may be configured to characterize the obtained voltage information of the gear shift control hardware to obtain the target I/O information for the atomic service layer 20 to call.

In the operations at block 130, the atomic service layer 20 may be configured to monitor representation information of hardware state changes (i.e. the target I/O information) sent by the I/O hardware abstraction layer 10, and may be configured to transmit a corresponding functional meaning interface to other modules after signal processing and filtering. That is, the atomic service layer 20 in the gear shift control system may be configured to determine an atomic service output gear based on the target I/O information output by the I/O hardware abstraction layer 10, and may be configured to transmit the atomic service output gear to the enhanced service layer 30.

In the operations at block S140, the enhanced service layer 30 may be configured to determine a target gear based on vehicle state information of the target vehicle and the atomic service output gear. That is, the enhanced service layer 30 may be configured to monitor a state of an atomic service related to the gear hardware and other atomic services of the vehicle, and may be configured to arbitrate and control monitored information for the gear shift control function of the gear application layer 40 to call.

It should be noted that the vehicle state information may include a brake pedal state, a drivable mode state, an electronic parking brake system state, and a vehicle driving speed and the like, and may also be set to include other information according to the actual situation, and it is not limited herein.

In the operations at block S150, the gear application layer 40 may be configured to control the gear of the target vehicle based on the target gear obtained from the enhanced service layer 30, thereby achieving gear shift control of the target vehicle.

In a case where the gear application layer 40 controls the gear of the target vehicle, the gear application layer 40 may be configured to first obtain an EPB state, the vehicle speed, torque information, and a power gear. The gear application layer 40 may also configured to obtain other information of the target vehicle according to actual need, and it is not limited herein. The above information is used to determine a specific parameter adjustment required for the target vehicle to adjust to the target gear, that is, the above information is used to determine a specific gear adjustment plan.

The gear application layer 40 may be configured to control the gear of the target vehicle based on the EPB state, the vehicle speed, the torque information, the power gear, and the target gear transmitted by the enhanced service layer 30, after obtaining the EPB state, the vehicle speed, the torque information, the power gear, and so on mentioned above.

Through the SOA architecture, including the gear shift control hardware layer 50, the I/O hardware abstraction layer 10, the atomic service layer 20, the enhanced service layer 30, and the gear application layer 40, the method may modularize and standardize originally dispersed electronic control units (ECUs) and basic software functions thereof in gear shift control, decouple various application domains from one another, and redeploy the various application domains into a layered software architecture. The vehicle can provide different gear shift control services through different software configurations without adding or replacing the hardware. The present disclosure may reduce coupling degree between the hardware and the software related to gear shift control, even decouple the corresponding software and the hardware, reduce the software versions and the code volume, improve the degree of software platformization, provide a personalized gear shift control service, and facilitate subsequent maintenance and upgrade of the gear shift control, thereby enhancing the gear shift control experience.

Some embodiments of the present disclosure provide a vehicle. The vehicle may be an electric car, a gasoline car, and so on. The embodiments of the present disclosure may impose no limitation on the specific type of vehicle.

Referring to FIG. 3, the vehicle 100 may include at least one processor 101, a memory 102, at least one network interface 104, and a user interface 103. Various components in the vehicle 100 are coupled together through a bus system 105. It can be understood that the bus system 105 is configured to achieve connection communication between these components. The bus system 105 includes not only a data bus, but also a power bus, a control bus, and a state signal bus. However, for the sake of clarity, various buses are labeled as bus system 105.

The user interface 103 may include a display, a keyboard, or a click on the vehicle (e.g., a mouse, a trackball, a touchpad, or a touch screen).

It can be understood that the memory 102 in the embodiments of the present disclosure may be a volatile memory or a non-volatile memory, or may include both the volatile memory and the non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM) used as an external cache. By way of example but not limitation, many types of RAM are available, such as a static random access memory (SRAM), a dynamic random access memory (DRAM), a synchronous DRAM (SDRAM), a double data rate SDRAM (DDRSDRAM), an enhanced SDRAM (ESDRAM), a synchronous link DRAM (SLDRAM), and a direct Rambus RAM (DRRAM). The memory 102 described herein is intended to include, but not be limited to, these and any other suitable types of memory.

In some embodiments, the memory 102 stores the following elements, i.e., an executable unit or a data structure, or a subset thereof, or an extension thereof, including an operating system 1021 and an application program 1022.

The operating system 1021 contains various system programs, such as a framework layer, a core library layer, a driver layer, and is configured to implement various basic businesses and handle hardware-based tasks. The application program 1022 includes various applications such as a media player, a browser, and is configured to implement various application services. The program for implementing the method of the embodiments of the present disclosure may be included in the application program 1022.

In the embodiments of the present disclosure, the processor 101 is configured to execute the methods provided by the various method embodiments by calling programs or instructions stored in the memory 102, specifically, programs or instructions stored in the application program 1022.

The method disclosed in the above embodiments of the present disclosure can be applied to processor 101 or implemented by the processor 101. The processor 101 may be an integrated circuit chip with a signal processing capability. In the implementation process, each operation of the above method may be completed through an integrated hardware logic circuit or a software instruction in the processor 101. The processor 101 mentioned above may be a general-purpose processor, a digital signal processor (DSP), an application specific integrated circuit (ASIC), a field programmable gate array (FPGA), or other programmable logic devices, discrete gates or transistor logic devices, or discrete hardware components, and is capable of implementing or executing the methods, operations, and logic block diagrams disclosed in the embodiments of the present disclosure. The general-purpose processor may be a microprocessor or any conventional processor. The operations of the method disclosed in the embodiments of the present disclosure can be directly reflected as being executed by a hardware decoding processor, or executed by a combination of hardware and software units in the decoding processor. The software unit may be located in well-known storage media in the art, such as a random access memory, a flash memory, a read-only memory, a programmable read-only memory, or an electrically erasable programmable memory, a register, and so on. The storage medium is located in the memory 102, and the processor 101 reads information from the memory 102 and completes the above method in combination with the hardware.

It can be understood that the embodiments described herein may be implemented by hardware, software, firmware, middleware, microcode, or a combination thereof. For a hardware implementation, the processing unit may be implemented in one or at least one application specific integrated circuit (ASIC), digital signal processing (DSP), digital signal processing vehicle (DSPD), programmable logic device (PLD), field programmable gate array (FPGA), general-purpose processor, controller, microcontroller, microprocessor, other electronic units used to perform the functions described in the present disclosure, or a combination thereof.

For software implementation, the techniques described herein may be achieved by the unit that performs the function described herein. A software code may be stored in the memory and executed by the processor. The memory may be implemented within the processor or externally to the processor.

Some embodiments of the present disclosure also provide a storage medium (i.e., a computer-readable storage medium). The storage medium here stores one or at least one program. The storage medium may include a volatile memory, such as a random access memory. The memory may also include a non-transitory memory, such as a read-only memory, a flash memory, a hard disk, or a solid-state disk. The memory may also include a combination of the above-mentioned types of memory.

The one or at least one program in the storage medium can be executed by the one or at least one processor. In a case where the storage medium is applied to a vehicle, the above-mentioned method executed on the vehicle can be implemented. The processor is configured to execute the vehicle control program stored in the memory, so as to implement the above-mentioned method executable on the vehicle.

Those skilled in the art should further realize that the units and algorithm operations described in each example disclosed herein may be implemented by electronic hardware, computer software, or a combination of both. In order to clearly illustrate the interchangeability of the hardware and the software, the composition and operations of each example have been generally described in the above description according to the functions. Whether the functions are executed in the hardware or the software depends on the specific application and the design constraint conditions of the technical solution. Those skilled in the art may use different methods to achieve the described functions for each specific application, but such implementation should not be considered beyond the scope of the present disclosure.

It should be noted that the terms “one implementation”, “embodiment”, “exemplary embodiments”, “some embodiments”, and the like mentioned in the specification indicate that the described embodiments may include a specific feature, a structure, or a characteristic, but not necessarily every embodiment includes the specific feature, the structure, or the characteristic. Furthermore, such phrases may not necessarily refer to the same embodiment. Moreover, when describing a specific feature, a structure, or a characteristic in conjunction with embodiments, it is within the knowledge of those skilled in the art to implement such feature, structure, or characteristic in conjunction with other embodiments that are explicitly or implicitly described.

It should be noted that related terms such as “first” and “second” herein are only used to distinguish one entity or operation from another, and do not necessarily require or imply any actual relationship or order between these entities or operations. Moreover, the terms “include”, “comprise”, “contain”, “have”, or any other variation thereof are intended to cover exclusive inclusion, such that a process, a method, a product, or a vehicle, including a series of elements, includes not only those listed elements, but also other elements not explicitly listed, or elements inherent to such process, method, product, or vehicle. Without further limitations, an element defined by the statement “including a . . . ” does not exclude the existence of other identical elements in the process, method, product, or vehicle that includes the element in question.

The above embodiments are merely preferred examples given to fully illustrate the present disclosure, and the protection scope of the present disclosure is not limited thereto. Any equivalent substitution or modification made by those skilled in the art on the basis of the present disclosure shall fall within the protection scope of the present disclosure.

1. A gear shift control method, applied to the gear shift control system, and the gear shift control method comprising:
obtaining voltage information of gear shift control hardware in a target vehicle;
determining target I/O information based on the voltage information;
determining an atomic service output gear based on the target I/O information;
determining a target gear based on vehicle state information of the target vehicle and the atomic service output gear; and
controlling a gear of the target vehicle based on the target gear.

2. The gear shift control method as claimed in claim 1, wherein the obtaining voltage information of gear shift control hardware in a target vehicle, comprises:
obtaining first voltage information corresponding to a parking gear in the gear shift control hardware; and
determining the first voltage information as information corresponding to the parking gear in the target I/O information.

3. The gear shift control method as claimed in claim 1, wherein the obtaining voltage information of gear shift control hardware in a target vehicle, comprises:
obtaining second voltage information corresponding to a non-parking gear in the gear shift control hardware;
abstracting the second voltage information into digital quantity information; and
determining the digital quantity information as information corresponding to the non-parking gear in the target I/O information.

4. The gear shift control method as claimed in claim 1, wherein the determining target I/O information based on the voltage information, comprises:
determining a fault state of the gear shift control hardware based on the target I/O information;
in a case where the gear shift control hardware is fault-free, transmitting a gear corresponding to the target I/O information in gear configuration information as the atomic service output gear; wherein the gear configuration information comprises at least one correspondence relationship between I/O information and the gear.

5. The gear shift control method as claimed in claim 1, wherein the vehicle state information comprises a brake pedal state, a drivable mode state, an electronic parking brake system state, and a vehicle driving speed, and the determining a target gear based on vehicle state information of the target vehicle and the atomic service output gear, comprises:
determining a driver gear demand based on the brake pedal state, a drivable mode state, an electronic parking brake system state, a vehicle driving speed, and the atomic service output gear; and
performing gear arbitration to determine the target gear based on an internal gear demand of a power system, an intelligent driving gear demand, and the driver gear demand.

6. The gear shift control method as claimed in claim 5, wherein a priority of the intelligent driving gear demand is higher than a priority of the internal gear demand of the power system, and the priority of the internal gear demand of the power system is higher than a priority of the driver gear demand.

7. The gear shift control method as claimed in claim 5, wherein the vehicle state information comprises a column shifter lever state, a power gear, and a set vehicle mode; and the determining a target gear based on vehicle state information of the target vehicle and the atomic service output gear, comprises:
determining the internal gear demand of the power system based on the column shifter lever state, the power gear, and the set vehicle mode.

8. The gear shift control method as claimed in claim 5, wherein the vehicle state information comprises an intelligent driving gear request state, the drivable mode state, and the vehicle driving speed; and the determining a target gear based on vehicle state information of the target vehicle and the atomic service output gear, comprises:
determining the intelligent driving gear demand based on the intelligent driving gear request state, the drivable mode state, and the vehicle driving speed.

9. The gear shift control method as claimed in claim 1, wherein the controlling a gear of the target vehicle based on the target gear, comprises:
obtaining an EPB state, the vehicle speed, torque information, and a power gear; and
controlling the gear of the target vehicle based on the EPB state, the vehicle speed, the torque information, the power gear, and the target gear.

10. A vehicle, comprising a processor and a memory, wherein the memory is configured to store a control program, in a case where the control program is executed by the processor, the processor is caused to perform:
obtaining voltage information of gear shift control hardware in a target vehicle;
determining target I/O information based on the voltage information;
determining an atomic service output gear based on the target I/O information;
determining a target gear based on vehicle state information of the target vehicle and the atomic service output gear; and
controlling a gear of the target vehicle based on the target gear.

11. The vehicle as claimed in claim 10, wherein in a case where the control program is executed by the processor, the processor is caused to perform:
obtaining first voltage information corresponding to a parking gear in the gear shift control hardware; and
determining the first voltage information as information corresponding to the parking gear in the target I/O information.

12. The vehicle as claimed in claim 10, wherein in a case where the control program is executed by the processor, the processor is caused to perform:
obtaining second voltage information corresponding to a non-parking gear in the gear shift control hardware;
abstracting the second voltage information into digital quantity information; and
determining the digital quantity information as information corresponding to the non-parking gear in the target I/O information.

13. The vehicle as claimed in claim 10, wherein in a case where the control program is executed by the processor, the processor is caused to perform:
determining a fault state of the gear shift control hardware based on the target I/O information;
in a case where the gear shift control hardware is fault-free, transmitting a gear corresponding to the target I/O information in gear configuration information as the atomic service output gear; wherein the gear configuration information comprises at least one correspondence relationship between I/O information and the gear.

14. The vehicle as claimed in claim 10, wherein the vehicle state information comprises a brake pedal state, a drivable mode state, an electronic parking brake system state, and a vehicle driving speed, and in a case where the control program is executed by the processor, the processor is caused to perform:
determining a driver gear demand based on the brake pedal state, a drivable mode state, an electronic parking brake system state, a vehicle driving speed, and the atomic service output gear; and
performing gear arbitration to determine the target gear based on an internal gear demand of a power system, an intelligent driving gear demand, and the driver gear demand.

15. The vehicle as claimed in claim 14, wherein a priority of the intelligent driving gear demand is higher than a priority of the internal gear demand of the power system, and the priority of the internal gear demand of the power system is higher than a priority of the driver gear demand.

16. The vehicle as claimed in claim 14, wherein the vehicle state information comprises a column shifter lever state, a power gear, and a set vehicle mode; and in a case where the control program is executed by the processor, the processor is caused to perform:
determining the internal gear demand of the power system based on the column shifter lever state, the power gear, and the set vehicle mode.

17. The vehicle as claimed in claim 14, wherein the vehicle state information comprises an intelligent driving gear request state, the drivable mode state, and the vehicle driving speed; and in a case where the control program is executed by the processor, the processor is caused to perform:
determining the intelligent driving gear demand based on the intelligent driving gear request state, the drivable mode state, and the vehicle driving speed.

18. The vehicle as claimed in claim 10, wherein in a case where the control program is executed by the processor, the processor is caused to perform:
obtaining an EPB state, the vehicle speed, torque information, and a power gear; and
controlling the gear of the target vehicle based on the EPB state, the vehicle speed, the torque information, the power gear, and the target gear.

19. A non-transitory computer-readable storage medium, wherein the non-transitory computer-readable storage medium stores one or at least one program, in a case where the one or at least one program is executed by one or at least one processor, the one or at least one processor is caused to perform:
obtaining voltage information of gear shift control hardware in a target vehicle;
determining target I/O information based on the voltage information;
determining an atomic service output gear based on the target I/O information;
determining a target gear based on vehicle state information of the target vehicle and the atomic service output gear; and
controlling a gear of the target vehicle based on the target gear.

20. The non-transitory computer-readable storage medium as claimed in claim 19, wherein in a case where the one or at least one program is executed by one or at least one processor, the one or at least one processor is caused to perform:
obtaining first voltage information corresponding to a parking gear in the gear shift control hardware; and
determining the first voltage information as information corresponding to the parking gear in the target I/O information.
